(19) United States
(12) Patent Application Publication
(10) Pub. No.: US 2014/0265006 A1
(43) Pub. Date: Sep. 18, 2014

(54) APPARATUS FOR MANUFACTURING AND PROCESSING FILMS

(71) Applicant: DAVIS-STANDARD, LLC, Pawcatuck, CT (US)

(72) Inventors: Robert F. Moeller, Baldwinsville, NY (US); Daniel F. Hould, Oswego, NY (US); Hassan Helmy, Branchburg, NJ (US)

(73) Assignee: DAVIS-STANDARD, LLC, Pawcatuck, CT (US)

(21) Appl. No.: 14/210,531

(22) Filed: Mar. 14, 2014

Related U.S. Application Data
(60) Provisional application No. 61/788,776, filed on Mar. 15, 2013.

(51) Int. Cl. B29D 7/01

(52) U.S. Cl. CPC B29D 7/01
USPC 264/146; 425/66

(57) ABSTRACT

A film processing apparatus includes a film delivery section and a film stretching section. The film stretching section is positioned downstream of the film delivery section. The film stretching section defines a first inlet and a first outlet. The film processing apparatus includes one or more slitting devices positioned between the first inlet and the first outlet.

### CROSS REFERENCE TO RELATED APPLICATIONS

This application claims priority to U.S. Provisional Patent Application Ser. No. 61/788,776, entitled “Apparatus for Manufacturing and Processing Films,” and filed Mar. 15, 2013, the subject matter of which is incorporated herein by reference.

### FIELD OF THE INVENTION

The present invention relates to the field of manufacturing films used for both machine film and hand film for packaging applications and in particular to an apparatus for improving the properties of the films and for processing of the films to facilitate handling thereof.

The present invention also relates to an apparatus and method of slitting a film within a stretching unit designed to enhance the film for the purpose of creating a stiffer load retaining film typically known as “hand stretch film” for the purpose of bundling or holding loose items or such as a palletized load. The apparatus can be implemented in-line with a blown or flat/embossed cast film producing process or off line where more than one slit lane of film is produced from an in-feeding film web.

### BACKGROUND OF THE INVENTION

Films, such as polymer films, can be produced by several different processes including blown film and chill roll casting. In the blown film method, the melt is extruded through an annular die to form a bubble which is expanded with internal air pressure. The bubble is then sized and air cooled with an air ring, internal bubble cooling and a sizing cage. The bubble is then collapsed in a nip thereby forming a double ply film that can be processed by Machine Direction Orientation (MDO) process. The film is then either slit separated and wound as two individual webs, or wound in double thickness without being separated.

In the casting of polymer films, polymers can be extruded through a die to form a melt curtain which is then rapidly quenched on a chill roll comprising an internally cooled roller or drum. The films can consist of one or more layers and can have a thickness of between 6 and 200 microns (0.24 to 7.9 mil, 1 mil=0.001 inches).

Various types of films can be manufactured from the aforementioned methods. One such film is a conventional stretch film that is used in hand (manual) or machine wrapping applications. The conventional stretch film is manufactured from specific materials (e.g., polyolefin polymers) with such characteristics and behavior that it can impart sufficient stretchability into the film so that the stretch film can be stretched as it is hand or machine wrapped around an object. For example, conventional stretch films can be used in bundling and packaging applications such as for securing bulky loads such as boxes, merchandise, produce, equipment, parts, and other similar items onto pallets.

The performance of the film to secure an object to a pallet (e.g., load retention performance) can be affected by the amount of stretch in the film, the strength of the film, the composition of the polymer, the number of wraps around the object and the strength of the edges of the film. Poor edge strength could result in tearing of the film during the wrapping process, particularly with high speed wrappers and thin films. Stretch films, particularly thin films at 10 micron and under, typically employ folded edges to increase the strength of the edge of the film. The films produced according to this process will be referred to herein as “conventional stretch films.”

Another type of film that can be manufactured from the aforementioned processes is a pre-stretch film. After processing, pre-stretch films are stiffer and thinner than conventional stretch film. The pre-stretch film is made by stretching or orientating a film beyond its yield point. However, the film material suitable for manufacturing pre-stretch film typically has a relatively lower viscosity and is a more stretchy (e.g., less stiff) compared to that of the polyolefin material used for conventional stretch films. The method of improving the stiffness properties of the films is referred to as the Machine Direction Orientation (MDO) process. In the MDO process, a film is stretched beyond its yield point (hot or cold) typically up to 300-400 percent, whereby its extendability (e.g. elastic stretchability) is greatly diminished. The film stretched in the MDO becomes stiffer and thinner and exhibits a greater load holding characteristic. Therefore, the pre-stretch film needs to be only minimally stretched (e.g., 20-40 percent, as compared with the conventional stretch film that requires up to 200 to 300 percent) during application to secure a load. During the stretching process in the MDO, the entire film decreases in thickness and decreases in width (i.e., neck-in process). However, due to the neck-in process the reduction in thickness of the film at the two free edges is not as pronounced as compared to remaining portions of the film between the free edges. As a result of the neck-in process that occurs during stretching, the free edges are naturally thicker than the remaining portions of the film. For example, the free edges of the film are typically 30-100 percent thicker than the rest of the film as a result of the neck-in, thereby strengthening the edge and eliminating the need for edge folding.

Cost reduction and environmental demands in recent years have resulted in a trend of thickness reduction for the hand (manual) as well as machine stretch films used in wrapping applications. It is more common to see stretch films under 17 microns down to 8 microns in those applications with thinner films comprising 3 to 35 layers (Nano films), but more typically 5 to 9 layers. Thinner films (12 microns and under) are typically made from lower melt index (higher viscosity) Polyolefin polymers to insure the production of stiffer and stronger stretch films to secure the wrapped product on the pallet. Thin films (e.g., 8-10 microns) are typically less stretchy than the prior art films having a conventional thicknesses of 20-25 microns. One side effect of thickness down gauging of those conventional stretch films, is that the edges of the film become fragile and more prone to damage (e.g., edge tearing) during handling as well as during the wrapping process. Referring to FIG. 1, in order to strengthen the edges 200 of a thin film 206 it is common to fold the edges 200 of the film to create a double thickness 2T of the film at both ends.

Another method to produce thinner stretch films is through producing thicker films (i.e., 17 to 25 microns) through an extrusion process (e.g., using cast or blown techniques) and then stretching the thicker films in an MDO prior to winding the thinner pre-stretch films having a thickness of about 6 to 10 micron. The film composition of those pre-stretch films are typically 3 to 5 layers of polyolefin resins with higher melt flow (e.g., 3-5 melt flow index) as compared with the lower melt flow resins (e.g., 1-3 melt flow index) used in making thin stiffer conventional stretch films as described herein. Melt flow index or MFI is a measure of the ease of flow of the melt of a thermoplastic polymer. It is defined as the mass of polymer, in grams, flowing in ten minutes through a capillary of a specific diameter and length by a pressure applied via prescribed alternative gravimetric weights for alternative prescribed temperatures. The method is described in standards ASTM D1238 and ISO 1133. Higher melt flow resins are typically easier to process than lower melt flow resins used in the manufacture of conventional stretch films and thus allow higher production speeds. As shown in FIG. 2A, a film 306 having a width W30 is fed to the stretching rollers 334A and 334B of the MDO 330. During the stretching process in the MDO 330, the film 306N necks-in and becomes narrower (i.e., width W32) than the width W30 prior to stretching. As the film 306N is stretched, the free edges 306E of the film 306N naturally remain thicker (e.g., a thickness T30E) than remaining portions of the film 306N which have a lesser thickness T30, due to the neck-in phenomenon as shown in FIG. 2B. The thickness of the free edges of the pre-stretch film typically increase to 30-100 percent of thickness of the rest of the film, thereby strengthening the free edge and eliminating the need for edge folding. The films produced according to this process (i.e., stretching via the MDO) will be referred to herein as “pre-stretch films.”

### SUMMARY

There is disclosed herein a film processing apparatus that includes a film delivery section and a film stretching section. The film stretching section is positioned downstream of the film delivery section. The film stretching section defines a first inlet and a first outlet. The film processing apparatus includes one or more slitting devices positioned between the first inlet and the first outlet.

There is also disclosed herein a method for manufacturing pre-stretch film. A film processing apparatus, which includes a film delivery section and a film stretching section positioned downstream of the film delivery section, is provided. A polymer suitable for producing the pre-stretch film is also provided. A film is formed from the polymer in the film delivery section. The film is fed to the film stretching section. The film is slit in the film stretching section.

### BRIEF DESCRIPTION OF THE DRAWINGS

FIG. 1 is a schematic diagram of a film processing apparatus of the present invention;

FIG. 2A is a schematic perspective view of a slitter device of FIG. 1;

FIG. 2B is a perspective view of an edge folder;

FIG. 2C is a top cross sectional view of the web before entering the edge folder;

FIG. 2D. is a top cross sectional view of the web in a first folding stage at a pre-fold bar;

FIG. 2E is a top cross sectional view of the web in a second folding stage at a pair of conical folding rolls;

FIG. 2F is a top cross sectional view of the web in a third folding stage at a folding plate;

FIG. 2G is a top cross sectional view of the web in a fourth folding stage at a lead out idler roller;

FIG. 3 is schematic top view of a film stretching section of the film processing apparatus of FIG. 1;

FIG. 4 is a schematic diagram of another embodiment of a film processing apparatus of the present invention;

FIG. 5 is schematic top view of a film stretching section of the film processing apparatus of FIG. 4;

FIG. 6 is a schematic diagram of the film processing apparatus of FIG. 1 including a steering guider assembly;

FIG. 7 is a schematic diagram of the film processing apparatus of FIG. 4 including a steering guider assembly;

FIG. 8 is a schematic top view of a steering guider assembly of FIGS. 6 and 7;

FIG. 9 is a schematic diagram of another embodiment of a film processing apparatus of the present invention;

FIG. 10 is a schematic diagram of another embodiment of a film processing apparatus of the present invention including a steering guider assembly;

FIG. 11 is a side elevation view of a steering assembly including a slitting device, an edge folder and a randomizer;

FIG. 12 is a perspective view of the steering assembly of FIG. 11;

FIG. 13 is a schematic illustration of a section of film with folded edges;

FIG. 14 is a schematic illustration of a section of film with thickened edges formed via a neck-in process during stretching;

FIG. 15 is a cross sectional view of the film of FIG. 14 taken across line 2B-2B;

FIG. 16A is a graph of stress versus strain of the film shown with the position of the stretch rollers and the slitting device being positioned before stretching;

FIG. 16B is a graph of stress versus strain of the film shown with the position of the stretch rollers and the slitting device being positioned during the linear elastic portion of the stretching;

FIG. 16C is a graph of stress versus strain of the film shown with the position of the stretch rollers and the slitting device being positioned between the linear elastic portion of the stretching and up and including the yield point of the film; and

FIG. 16D is a graph of stress versus strain of the film shown with the position of the stretch rollers and the slitting device being positioned after the yield point of the film.

### DETAILED DESCRIPTION OF THE INVENTION

As shown in FIG. 1, a film processing apparatus is generally designated by the numeral 10. The film processing apparatus 10 includes a film delivery section 20 and a film stretching section 30 (e.g., MDO) positioned downstream of the film delivery section 20. The film processing apparatus 10 includes a film receiving section 40 positioned downstream of the film stretching section 30. The film stretching section includes an inlet 31 and an outlet 32. A slitting device 33 is positioned within the film stretching section 30, between the inlet 31 and the outlet 32. However, in one embodiment the slitting device 33 is positioned before the film stretching section 30.

As shown in FIG. 1, the film delivery section 20 includes a film production device, for example a casting device including a material feeder 21, such as a die which discharges molten material 6M from an outlet 21A thereof onto a casting drum 22. The outlet 21A of the die 21 is spaced apart from the drum 22 by a distance DD, as shown in FIG. 1. In one embodiment, the distance DD is about 0.25 to 5.0 inches (6.35 to 127 mm). A die gap is a generally linear opening in the die of about 1 mm as indicated by the letter G in FIG. 1. The die gap G is typically adjustable by means of die bolts (not shown) proximate the exit of die to reduce the die gap G of 1 mm down to 0.80 to 0.25 mm for the purpose of producing different film thickness out of the die gap G. Reducing the die gap G reduces the thickness of the film. In one embodiment, the material is a polymer having a suitable melt flow, viscosity and composition for making pre-stretch film.

As shown in FIG. 1, the film delivery section 20 includes the rotatable drum 22 which defines an exterior surface 22E and which is configured to rotate about an axis 22A, for example, in the direction indicated by the arrow R1. The molten material 6M is transferred to the exterior surface 22E of the drum 22 via the outlet 21A while the drum is rotating. The drum 22 is maintained at a constant temperature for cooling and solidifying the molten material 6M to produce a thin film 6 thereon. Such constant cooling temperature of the cooling drum can be increased or decreased by means of the temperature control system of the cooling drum to suit the process of the stretch film manufacturing. In one embodiment, the drum is a heat sink which cools and solidifies the molten material 6M. The film 6 is stretchable below its yield point, however it is permanently deformed and stretched at or above its yield point. The film delivery section 20 includes one or more delivery rollers 23, for example two idler rollers 23A and 23B over which the film 6 is fed and discharged from the delivery section 20 in the general direction of arrows F1 and F2 to the film stretching section 30.

As illustrated in FIG. 1, the film stretching section 30 includes five stretching rollers 34A, 34B, 34C, 34D and 34E. The stretching rollers 34A (i.e., a first stretching roller), 34B (a second stretching roller), 34C (a third stretching roller), 34D (a fourth stretching roller), and 34E (a fifth or last stretching roller), are rotated at different surface speeds to cause the film 6 to stretch beyond the yield point of the material. For example, the last stretching roller 34E is rotated at a surface speed greater than that of the fourth stretching roller 34D; the fourth stretching roller 34D is rotated at a surface speed greater than that of the third stretching roller 34C; the third stretching roller 34C is rotated at a surface speed greater than that of second stretching roller 34B; and/or the second stretching roller 34B is rotated at a surface speed greater than that of the first stretching roller 34A. In one embodiment, the surface speeds of the stretching rollers 34A, 34B, 34C, 34D and 34E are selectively adjusted to a predetermined magnitude to cause the surface speed of the last stretching roller 34E to exceed the surface speed of the first stretching roller 34A by about 200 percent to about 400 percent. While the surface speed of the last stretching roller 34E is said to exceed the surface speed of the first stretching roller 34A by about 200 percent to about 400 percent, the present invention is not limited in this regard as any ratio of speeds sufficient to stretch the film 6 may be employed including but not limited to the surface speed of the last stretching roller 34E exceeding the surface speed of the first stretching roller 34A by about 200 percent or more, at least 250 percent, at least 275 percent or up to about 400 percent. The speeds of the rollers 34A, 34B, 34C, 34D and 34E are directly proportional to the amount of stretching. Thus, the film 6 is stretched from between 50 percent and about 250 percent, 275 percent, 300 percent or 400 percent or any percent between those ratios.

In one embodiment, heat may be added to the film stretching section 30 to soften the film 6 for the purpose of stretching more easily or to attain various stiffness properties.

As illustrated in FIG. 3, the stretching rollers 34A, 34B, 34C, 34D and 34E are rotated and the film is fed in a serpentine way as to allow close coupled stretching of the film between each of the rollers where by stretching can be accomplished between different portions of each of the stretching rollers. In the example embodiment shown in FIG. 1, the first stretching roller 34A is rotated in a counter clockwise direction RA and the film is fed in the counter clockwise direction RA over a bottom portion of the first stretching roller 34A; the second stretching roller 34B is rotated in a clockwise direction RB and the film 6 is fed in the clockwise direction RB over a top portion of the stretching roller 34B; the third stretching roller 34C is rotated in a clockwise direction and the film is fed in a clockwise direction over a top portion of the third stretching roller 34C; the fourth stretching roller 34D is rotated in a counter clockwise direction RD and the film is fed in the counter clockwise direction RD over a bottom portion of the fourth stretching roller 34A; and the fifth stretching roller 34E is rotated in a clockwise direction RE and the film is fed in the clockwise direction RE over a top portion of the fifth stretching roller 34E for the purpose of controlling orientation rate and minimizing loss in width of the stretching process. The gap between each of the stretching rollers can be fixed or adjustable between 0.005 and 1.0 inches (0.126 and 25.4 mm).

As shown in FIG. 1, the film receiving section 40 includes two idler rollers 41A and 41B over which the pre-stretch film 6 sections travel as the idler rollers 41A and 41B rotate. The film receiving section 40 includes a winding apparatus, for example, a drum 42 rotatably mounted about an axis 42A for winding the slit pre-stretch film 6P thereon. The slit pre-stretch film 6P is fed onto the drum 42 and is wound into separate reels.

As illustrated in FIGS. 3 and 7, a slitting device 33 is disposed within the film stretching section 30 between the inlet 31 and the outlet 32 (i.e., between the stretching rollers 34A and 34E). For example the slitting device 33 is positioned between the second drive roller 34B and the third drive roller 34C. While the slitting device 33 is shown and described as being positioned between the second drive roller 34B and the third drive roller 34C, the present invention is not limited in this regard as the slitting device may be positioned in other suitable locations for example, but not limited to, between the first drive roller 34A and second drive roller 34B; between the third drive roller 34C and the fourth drive roller 34D; and/or between the fourth drive roller 34D and the fifth drive roller 34E. In addition, the slitting device 33 may be positioned upstream of the film stretching section 30, for example as described herein with reference to FIGS. 9 and 10.

As illustrated in FIG. 3, the film 6 having a width W3 is fed to the stretching section 30. The slitting device 33 is positioned between the second stretching roller 34B and the third stretching roller 34C. A portion of the slitting device 33 extends through and cuts the film 6 into two strips 6P1 and 6P2 as the film 6 travels past the slitting device 33 in the general direction of the arrow F3. When the film 6 is initially slit, the strips 6P1 and 6P2 have initial widths of W4, measured between opposing edges 6E. After the strips 6P1 and 6P2 are stretched by traveling through the stretching rollers 34C and 34D, the strips 6P1 and 6P2 become more narrow (e.g., neck-in) and have a second width W5 (e.g., 17.5 inches, 444.5 mm), which is less than the width W4 (e.g., 20 inches, 508 mm). The strips 6P1 and 6P2 continue to become more narrow (third width W6) as the strips are further stretched as a result of travel over the stretching roller 34E. The reduction in width due to neck-in adds to the thickness of the edges of 6E.

While the film 6 is described as being slit into two strips 6P1 and 6P2, the present invention is not limited in this regard as any number of slitting devices may be employed to slit the film into any number of strips.

In one embodiment, side edges 6T (e.g., trim), shown in FIG. 11 are slit or trimmed off with another slitting device 33, in the film stretching device 30 and before slitting of the film 6 with the film slitting devices 33.

Referring to FIG. 1, the film receiving section 40 includes two idler rollers 41A and 41B over which the slit film 6P travels as the idler rollers rotate. The film receiving section 40 includes a winding apparatus, for example, a drum 42 rotatably mounted about an axis 42A for winding the slit film 6P thereon. The slit film 6P is fed onto the drum 42. In one embodiment, the drum 42 includes one or more spindles 44A, 44B, 44C and 44D (see FIG. 8, for example) for winding respective ones of the strips 6P1, 6P2, 6P3 and 6P4 thereon.

Referring to FIGS. 4 and 5, the film processing apparatus 110 is similar to the film processing apparatus 10, except that the film processing apparatus 110 includes an edge folder 35 positioned between the slitting device 33 and the third roller 34C.

As shown in FIG. 2B, the edge folder 35 is mounted on a rail 79 of a steering assembly 90 as described further herein with reference to FIGS. 11-13. As illustrated in FIG. 2B, the edge folder 35 includes a base plate 81 selectively secured to a predetermined position on the rail 79 by a suitable bracket 81A. Two L-shaped support bars 82A and 82B each have a first end secured an opposing end of the base plate 81. A second end of each of the L-shaped bars 82A and 82B has a second plate 83 secured thereto. A pre-fold bar 84 has one end secured to the base plate 81 between the L-shaped bars 82A and 82B. A distal end of the pre-fold bar 84 extends away from the base plate 81 and is generally perpendicular to the baseplate 81.

As illustrated in FIG. 2B, each of the L-shaped bars 82A and 82B has a bore 85 extending therethrough. The bores 85 are located proximate to and are spaced apart from the second plate 83. The bores 85 are concentric with one another. A pin 86 is secured in each of the bores 85. A first conical roller 87A and a second conical roller 87B are rotatably mounted on the pin 86. A base portion 87C of the conical roller 87A faces a base portion 87D of the conical roller 87B. The base portion 87C is spaced apart from the base portion 87D thereby defining a gap G1 therebetween. In one embodiment, the first conical roller 87A and the second conical roller 87B are moveably and selectively positioned on the pin 86 to set the gap G1 at any predetermined magnitude.

As shown in FIG. 2B, an angled folding plate 88 is secured to a bottom side 83B of the second plate 83. The angled folding plate 88 includes a first plate section 88A and a second plate section 88B that are oriented at an angle A1 from each other. In one embodiment, the angle A1 is about 90 degrees. While the angle A1 is described as being about 90 degrees, the present invention is not limited in this regard as any suitable angle may be employed, including but not limited to 120, 110, 100, 80, 70, 60 or 50 degrees or any other suitable angle.

As illustrated in FIG. 2B an out-feed roller 89, for example an idler roller is positioned downstream of the angled folding plate 88. The out-feed roller 89 is positioned below and is spaced apart from the angled folding plate 88. The out-feed roller 89 imparts a final fold on the edge of the web as described below.

Referring to FIGS. 2C-2G and 11, the edge folder 35 folds an edge 6E of a web in a four step process after the film 6 is slit, for example, into the strips 6P1 and 6P2 by the slitting device 33. The strips 6P1 and 6P2 are positioned generally proximate to and spaced apart from a front face 35F of the edge folder 35, as illustrated in FIG. 11 which shows the slitting device 33, the edge folder 35 and the randomizer 266, positioned in a single steering assembly 90, as described further herein. After the film 6 is slit into the strips 6P1 and 6P2 the edges 6E of the strips 6P1 and 6P2 face each other, as illustrated in FIG. 2C. The strips 6P1 and 6P2 are pulled through the steering assembly 90 away from the slitting device 33. The edges 6E of strips 6P1 and 6P2 slidingly engage opposing sides of the pre-folding bar 84 and are curled inwardly toward the front face 35F of the edge folder as shown in FIG. 2D. The edge 6E of the strip 6P1 is fed through the gap G1 and contacts the base portion 87C of the conical roller 87A to create a bend 6B that is approximately perpendicular to the remaining portions of the strip as shown in FIG. 2E. The edge 6E of the strip 6P2 is fed through the gap G1 and contacts the base portion 87D of the conical roller 87B to create a an upward bend 6B that is approximately perpendicular to the remaining portions of the strip 6P2 as shown in FIG. 2E. After engaging the base portions 87C and 87D of the conical rollers 87A and 87B, respectively, the bends 6B are pulled over the first plate section 88A and the second plate section 88B of the angled folding plate 88 thereby causing the bend 6B to fold further towards and over (e.g., fold an additional angular amount equal to about one half of the angle A1, for example 45 degrees) the remaining portions of the strips 6P1 and 6P2 as shown in FIG. 2F. After engaging the angled folding plate 88, the bends 6B engage an outer surface 89E defined by the out-feed roller 89 thereby causing the bend 6B to lay flat against and engage a peripheral portion of top portions of the respective strip 6P1 and 6P2 and creating a folded edge 6EE, as shown in FIG. 2G.

The film processing apparatus 10 of FIG. 6 is similar to the film processing apparatus 10 of FIGS. 1 and 3, except that the film processing apparatus 10 of FIG. 6 includes a steering assembly 50 positioned between the fifth drive roller 34E of the film stretcher 34 and the film receiving section 40; and the drum 42 of the receiving section 40 includes four spindles 44A, 44B, 44C, and 44D abutting one another along the axis 42A.

Referring to FIGS. 6 and 8, the steering assembly 50 includes an idler roller 50A and four guides 51A, 51B, 51C and 51D positioned between the idler roller 50A and the film receiving section 40. In one embodiment, the guides 51A, 51B, 51C and/or 51D are individual idler rollers. Each of the guides 51A, 51B, 51C and 51D are configured to laterally move respective ones of the strips 6P1, 6P2, 6P3 and 6P4 into alignment with a respective one of the four spindles 44A, 44B, 44C, and 44D. For example, the guide 51A laterally moves the strip 6P3 in the direction indicated by the arrow 52A to align the strip 6P3 with the spindle 44C; the guide 51B laterally moves the strip 6P4 in the direction indicated by the arrow 52B to align the strip 6P4 with the spindle 44D; the guide 51C laterally moves the strip 6P1 in the direction indicated by the arrow 52C to align the strip 6P1 with the spindle 44A; and the guide 51D laterally moves the strip 6P2 in the direction indicated by the arrow 52D to align the strip 6P2 with the spindle 44B. The steering assembly has utility in eliminating the need to space the spindles 44A, 44B, 44C, and 44D apart from one another to account for the progressive narrowing of the strips 6P1, 6P2, 6P3 and 6P4, from the width W4 to the width W5 to the width W6, as described above. In one embodiment, the guides 51A, 51B, 51C and/or 51D are movably mounted (e.g., configured to be cocked or twisted askew from a longitudinal axis of the guides 51A, 51B, 51C and/or 51D) to adjust the lateral position of the strips 6P1, 6P2, 6P3 and 6P4, respectively, during operation of the film processing apparatus 10.

Referring to FIG. 6, the film receiving section 40 includes a pull roller 48A and an idler roller 48B between which the film is de-tensioned and creating a low tension region 43 between the pull roller 48A and downstream idler rollers 49 and 41A.

The film processing apparatus 110 of FIG. 7 is similar to the film processing apparatus 110 of FIGS. 4 and 5, except that the film processing apparatus 10 of FIG. 7 includes a steering assembly 50, as shown in FIG. 8, positioned between the fifth drive roller 34E of the film stretcher 34 and the film receiving section 40; and the drum 42 of the receiving section 40 includes four spindles 44A, 44B, 44C, and 44D (e.g., cardboard, plastic or paper cores) abutting one another along the axis 42A. The strips 6P1, 6P2, 6P3 and 6P4 are wound onto the spindles 44A, 44B, 44C, and 44D, respectively. In one embodiment, the strips 6P1, 6P2, 6P3 and 6P4 are wound onto the spindles 44A, 44B, 44C, and 44D leaving a gap of about 4 to 6 mm between the folded edge 6EE and each of two opposing ends of the respective spindle 44A, 44B, 44C, and 44D.

The film processing apparatus 210 of FIG. 9 is similar to the film processing apparatus 110 of FIGS. 4 and 5, except that the film processing apparatus 210 of FIG. 9 includes a pre-stretching section 260 positioned between the film delivery section 220 and the film stretching section 230 (e.g., MDO). The pre-stretching section 260 stretches the film to an elongation lower than a yield point of the film. The pre-stretching section 260 includes a slitting device 233 and an edge folder 235, positioned downstream of the slitting device 233 similar to the slitting device 33 and edge folder 35 described herein with references to FIGS. 1-5. The slitting device 233 is positioned between two idler rollers 261A and 261B. The pre-stretching section 260 includes a randomizer 266 pivotally connected to the slitting device 233 and the edge folder 235 as described with reference to FIG. 11 herein. The randomizer 266 includes an oscillating device 266A configured cause the randomizer 266 to randomly move the slitter device 233 and the edge folder 235 for randomization of folded edge 6EE of the film 6 and offset gauge band buildup during downstream processing of the strips 6P1, 6P2, for example in the film stretching section 230 or winding of the film 6 on a drum 42 of a winding apparatus (the drum and winding apparatus is shown in FIG. 1) as described with reference to FIG. 11 herein. In one embodiment, the winding of the randomized folded edges 6EE of the film 6 is referred to as wiggle-winding. The gauge band buildup is an abrupt increase in thickness of the film 6 in the transverse direction of the film 6.

In addition, the film delivery section 220 of the film processing apparatus 210 of FIG. 9 includes an additional idler roller 223C adjacent to the drive roller 223B which cooperate to guide and pull the film 6 therebetween. In addition, the film stretching section 230 includes additional idler rollers 234F, 234G and 234H and only four drive rollers 234A, 234B, 234C and 234D.

The film processing apparatus 310 of FIG. 10 is similar to the film processing apparatus 210 of FIG. 9, except that the film processing apparatus 310 includes another idler roller 223D and a steering assembly 250, similar to the steering assembly 50 described herein with reference to FIGS. 7 and 8.

Referring to FIGS. 11 and 12, a single steering assembly 90 has a randomizer 266 that has a frame portion 266F fixedly secured to a stationary frame (not shown). The randomizer 266 also includes a moveable frame 91, as described herein. The steering assembly 90 is positionable as an integral unit in any predetermined position in the film processing apparatus 10, 210 or 310. For example, the steering assembly 90 is positionable upstream of the film stretching section 230 as shown in FIGS. 9 and 10.

As shown in FIG. 11, the randomizer 266 has a drive assembly including a motor 269 rotatably coupled to a gear box 269G. The drive assembly is secured to the frame 266F. The randomizer 266 includes a randomizer sub-assembly 266 or oscillator assembly 266 that includes an eccentric device 266E driven by an output shaft 269S of the gear box 269G. The oscillator assembly 266 moveably couples the drive assembly to the moveable frame 91 to impart an oscillatory motion of the moveable frame 91. The eccentric device 266E has an output pin 266P pivotaly coupled to a drive rod 266K. The moveable frame portion 91 is moveably mounted on rails 266R with the use of suitable bearings 266L (e.g., linear or curvilinear bearings). The frame 266F has an in-feed idler roller 97, a plurality of slitting devices 33 (e.g., five slitting devices are shown), a plurality of edge folders 35 (e.g., five edge folders are shown) and the out-feed roller 89 mounted thereon. The drive rod 266K is pivotally coupled to the moveable frame 91.

During operation, the motor 269 causes the shaft 269S to turn which causes the eccentric device 266E to cause the drive rod 266K to move the moveable frame 91 relative to the frame 266F, for example in a linear or curvilinear manner in general direction indicated by the arrow A7. During operation, a film 6 is fed in the direction indicated by the arrow A5 to the in-feed idler roll 97, is slit by the slitting devices 33 into a plurality of strips (e.g., 6P1, 6P2, etc.), the plurality of strips have folded edges 6EE formed thereon by the edge folding devices 35 and the strips are discharged in the direction indicated by the arrow A6 out of the steering assembly 90 in a randomized side-to-side (see arrow A7) manner for use in a downstream device, such as, but not limited to, a film stretching section 230.

Referring to FIGS. 11 and 12, in one embodiment, the slitting device 33 is moveable between an operating position and set-up position (e.g., for manual threading of the film 6) in the general direction indicated by the arrow A8 by an actuator 92. In one embodiment, the edge folder 35 is moveable between an engaged position and a disengaged position (e.g., for manual threading of the film 6 or selective disengagement during operation) in the general direction indicated by the arrow A9 by an actuator 93. In one embodiment, the steering unit 90 includes a trim roll 99 for collecting excess or non-uniform edge material 6T (e.g., 1 to 4 inches, 25.4 to 10.6 mm, width of excess film) from edges of the film 6.

Referring to FIG. 16A-16D, four graphs 500A, 500B, 500C and 500D each of which include an Y axis 501 indicating stress (psi) imposed on the film 6 versus elongation % of the film 6, on a first X axis 502. In addition, the graphs 500A, 500B, 500C and 500D each include a second X axis indicating position of the slitting device 33. The graphs 500A, 500B, 500C and 500D also include a third X axis which indicates the position of the rollers 34A and 34 E and the film stretching section 30. Each of the graphs 500A, 500B, 500C and 500D also include a stress versus strain curve 510 that defines a region of zero strain 555, a region of linear elastic strain 520, a region of non-linear elastic strain 530, a yield point YP and a region of plastic strain 540. The yield point YP is defined as the point at which an increase in stress results in plastic deformation of the film. The yield point YP of the film 6 occurs at an elongation of between about 50 to 250%, depending on the composition of the film material used.

Referring to FIG. 16A, the slitting device 33 is positioned before the film stretching section 30 in the region of zero strain 555.

Referring to FIG. 16B, film stretching section 30 defines a first subsection 631 configured to stretch the film 6 in the linear elastic range 520 and the slitting device 33 is positioned in the first subsection 631.

Referring to FIG. 16C, the film stretching section 30 defines a second subsection 632 configured to stretch the film 6 in the non-linear elastic range 520 and the slitting device 33 is positioned in the second subsection 632.

Referring to FIG. 16D, the film stretching section 30 defines a third subsection 633 configured to stretch the film 6 in the plastic range 540 and the slitting device 33 is positioned in the third subsection 633.

In one embodiment, the third subsection 633 includes a fourth subsection 634 configured to stretch the film 6 in the plastic range 540 after 250 percent elongation and the slitting device 33 is positioned in the fourth subsection 644, as shown in FIG. 16D. In one embodiment, the third subsection 633 includes a fourth subsection 634 configured to stretch the film 6 in the plastic range 540 after 275 percent elongation and the slitting device 33 is positioned in the fourth subsection 644, as shown in FIG. 16D.

The present invention includes a method for manufacturing pre-stretch film. The method includes providing a film processing apparatus 10 as shown in FIG. 1. The film processing apparatus 10 includes a film delivery section 20 and a film stretching section 30 positioned downstream of the film delivery section 20. A polymer suitable for producing the pre-stretch film is provided to the film delivery section 20. A film 6 is formed from the polymer in the film delivery section 20. The film 6 is fed to the film stretching section 30. The film 6 is slit in the stretching section 30.

Although the present invention has been disclosed and described with reference to certain embodiments thereof, it should be noted that other variations and modifications may be made, and it is intended that the following claims cover the variations and modifications within the true scope of the invention.

What is claimed is:

1. A film processing apparatus comprising:
a film delivery section;
a film stretching section defining a first inlet and a first outlet, the film stretching section being positioned downstream of the film delivery section; and
at least one slitting device positioned between the first inlet and the first outlet.

2. The film processing apparatus of claim 1, wherein slitting device is positioned to slit the film before a yield point of the film.

3. The film processing apparatus of claim 1, wherein slitting device is positioned to slit the film after a yield point of the film.

4. The film processing apparatus of claim 1, wherein slitting device is positioned to slit the film before stretching the film 50 percent.

5. The film processing apparatus of claim 1, wherein slitting device is positioned to slit the film before stretching the film 150 percent.

6. The film processing apparatus of claim 1, wherein slitting device is positioned to slit the film before stretching the film 250 percent.

7. The film processing apparatus of claim 1, wherein slitting device is positioned to slit the film before stretching the film 300 percent.

8. The film processing apparatus of claim 1, wherein slitting device is positioned to slit the film after stretching the film 250 percent.

9. The film processing apparatus of claim 1, wherein slitting device is positioned to slit the film after stretching the film 275 percent.

10. A method for manufacturing pre-stretch film, the method comprising:
providing a film processing apparatus comprising a film delivery section and a film stretching section positioned downstream of the film delivery section;
providing a polymer suitable for producing the pre-stretch film;
forming a film in the polymer in the film delivery section;
feeding the film to the film stretching section; and
slitting the film in the film stretching section.

11. The method of claim 10, wherein the film is slit before a yield point of the film.

12. The method of claim 10, wherein the film is slit after a yield point of the film.

13. The method of claim 10, wherein the film is slit before stretching the film 50 percent.

14. The method of claim 10, wherein the film is slit before stretching the film 150 percent.

15. The method of claim 10, wherein the film is slit before stretching the film 250 percent.

16. The method of claim 10, wherein the film is slit before stretching the film 300 percent.

17. The method of claim 10, wherein the film is slit after stretching the film 50 percent.

18. The method of claim 10, wherein the film is slit after stretching the film 250 percent.

19. The method of claim 10, wherein the film is slit after stretching the film 275 percent.
